(19) United States
(12) Patent Application Publication
(10) Pub. No.: US 2014/0126908 A1
(43) Pub. Date: May 8, 2014

(54) System and Method for Enabling Energy Efficiency Over Ethernet Links in Consideration of Optical Network Transport Equipment

(71) Applicant: Broadcom Corporation, Irvine, CA (US)

(72) Inventor: Wael William Diab, San Francisco, CA (US)

(73) Assignee: Broadcom Corporation, Irvine, CA (US)

(21) Appl. No.: 13/952,977

(22) Filed: Jul. 29, 2013

Related U.S. Application Data
(60) Provisional application No. 61/723,663, filed on Nov. 7, 2012.

(51) Int. Cl. H04B 10/564

(52) U.S. Cl. CPC H04B 10/564
USPC 398/58

(57) ABSTRACT

A system and method for enabling energy efficiency over Ethernet links in consideration of optical transport network (OTN) equipment. It is a feature of the present invention that a secondary startup condition can be provided whereby the energy efficiency Ethernet operation in a link partner is conditionally enabled upon a transmission by the link partner of an initiation signal (e.g., reserved or unused code group) that would be semi-acceptable to a legacy physical coding sublayer (PCS) in OTN equipment and a receipt by the link partner of valid energy efficient Ethernet signaling.

This application claims priority to provisional application No. 61/723,663, filed Nov. 7, 2012, which is incorporated herein by reference in its entirety.

### BACKGROUND

1. Field of the Invention

The present invention relates generally to networking and, more particularly, to a system and method for enabling energy efficiency over Ethernet links in consideration of optical transport network equipment.

2. Introduction

Energy costs continue to escalate in a trend that has accelerated in recent years. Such being the case, various industries have become increasingly sensitive to the impact of those rising costs. One area that has drawn increasing scrutiny is the IT infrastructure. Many companies are now looking at their IT systems' power usage to determine whether the energy costs can be reduced. For this reason, an industry focus on energy efficient networks (IEEE 802.3az) has arisen to address the rising costs of IT equipment usage as a whole (i.e., PCs, displays, printers, switches, servers, network equipment, etc.).

In designing an energy efficient solution, one of the considerations is network link utilization. For example, many network links are typically in an idle state between sporadic bursts of data traffic. An additional consideration for an energy efficient solution is the extent to which the traffic is sensitive to buffering and latency. For example, some traffic patterns (e.g., HPC cluster or high-end 24-hr data center) are very sensitive to latency such that buffering would be problematic.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an example embodiment of an Ethernet link between link partners incorporating principles of the present invention.

FIG. 2 illustrates an example of a LLDP Data Unit used by the present invention.

FIGS. 3A and 3B illustrate example application scenarios of a secondary startup condition used in an Ethernet link.

FIG. 4 illustrates a flowchart of an example process of the present invention.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Energy efficient Ethernet networks attempt to save power when the traffic utilization of the network is not at its maximum capacity. ITU G.709 defines a mapping function that allows for transport of Ethernet over optical transport network (OTN) links. In the present invention, it is recognized that when energy efficient Ethernet is enabled on links having OTN equipment between the Ethernet link partners, the energy efficient Ethernet signaling transported over the link can result in errors.

It is a feature of the present invention that a secondary startup condition can be provided whereby the energy efficiency Ethernet operation in a link partner is conditionally enabled upon a transmission by the link partner of a signal (e.g., reserved or unused code group) that would be at least semi-acceptable to a legacy physical coding sublayer (PCS) in OTN equipment and a receipt by the link partner of valid energy efficient Ethernet signaling. Where a legacy PCS in OTN equipment is included within the Ethernet link, the legacy PCS will receive the signal and either do nothing or cause a single error. In either case, the Ethernet link will not be dropped. As the legacy PCS would not forward the signal on to the Ethernet link partner, energy efficient Ethernet would not be enabled.

In one embodiment, a process according to the present invention would include transmitting a first link layer protocol packet from a first link partner to a second link partner, wherein the first link layer protocol packet advertising first energy efficiency control policy capabilities that are supported by the first link partner, transmitting a physical coding sublayer code group from the first link partner to the second link partner, and activating a state machine that governs an energy efficiency control policy in the first link partner upon receipt of energy efficiency signaling by the first link partner that is transmitted from the second link partner, wherein the transmission of the energy efficiency signaling by the second link partner is conditioned on receipt by the second link partner of the physical coding sublayer code group.

In interfaces such as optical physical layer devices that do not support auto-negotiation, configuration of an energy efficiency Ethernet operation can be enabled through link layer protocol messaging that advertises energy efficiency capabilities and features between link partners. In one embodiment, the link layer protocol packet is a Link Layer Discovery Protocol (LLDP) message packet. As would be appreciated, various other higher-layer protocols can be used without departing from the scope of the present invention.

In various embodiments, the supported energy efficiency protocol enables support for one or more energy efficiency operating modes (e.g., low power idle mode, subset physical layer device mode, etc.) that have a reduced power consumption relative to an active operating mode of the first link partner. Upon receipt by the first link partner of a second link layer protocol packet from the second link partner over the fiber optic network cable, the first link partner can then activate energy efficiency features. In one embodiment, the first link partner activates a energy efficiency state machine that governs the behavior of the energy efficiency control protocol.

In general, the energy efficiency control protocol can be used to minimize a transmission performance impact while maximizing energy savings. At a broad level, an energy efficiency control policy for a particular link in the network determines when to enter an energy saving state, what energy saving state (i.e., level of energy savings) to enter, how long to remain in that energy saving state, what energy saving state to transition to out of the previous energy saving state, etc. In one embodiment, energy efficiency control policies can base these energy-saving decisions on a combination of settings established by an IT manager and the properties of the traffic on the link itself.

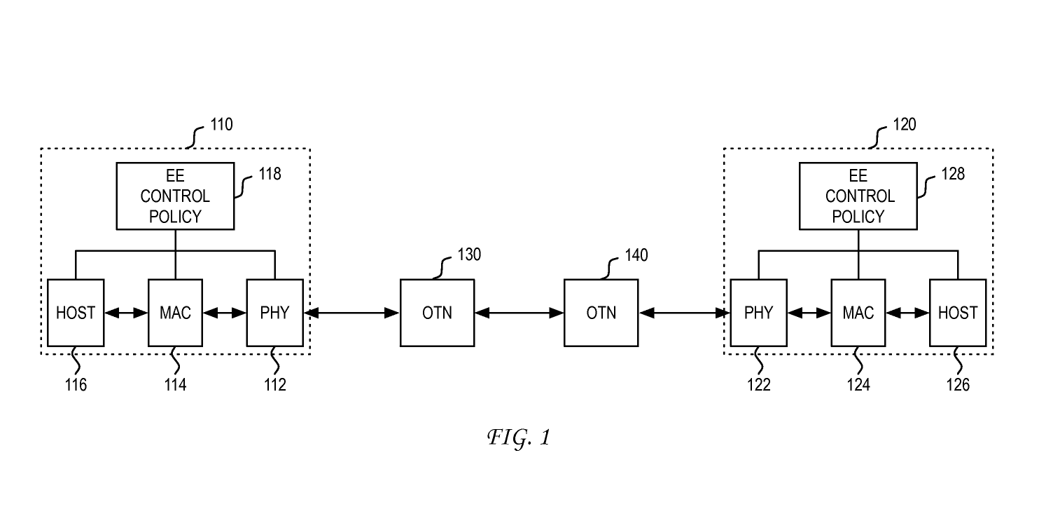

FIG. 1 illustrates an example embodiment of an Ethernet link between link partners incorporating principles of the present invention. As illustrated, the Ethernet link supports communication between a first link partner 110 and a second link partner 120. In various embodiments, link partners 110 and 120 can represent a switch, router, endpoint (e.g., server, client, VOIP phone, wireless access point, etc.), or the like. As illustrated, link partner 110 includes physical layer device (PHY) 112, media access control (MAC) 114, and host 116, while link partner 120 includes PHY 122, MAC 124, and host 126.

In general, hosts 116 and 126 may comprise suitable logic, circuitry, and/or code that may enable operability and/or functionality of the five highest functional layers for data packets that are to be transmitted over the link. Since each layer in the Open Systems Interconnection (OSI) model provides a service to the immediately higher interfacing layer, MAC controllers 114 and 124 may provide the necessary services to hosts 116 and 126 to ensure that packets are suitably formatted and communicated to PHYs 112 and 122, respectively. MAC controllers 114 and 124 may comprise suitable logic, circuitry, and/or code that may enable handling of data link layer (Layer 2) operability and/or functionality. MAC controllers 114 and 124 can be configured to implement Ethernet protocols, such as those based on the IEEE 802.3 standard, for example. PHYs 112 and 122 can be configured to handle physical layer requirements, which include, but are not limited to, packetization, data transfer and serialization/deserialization (SERDES).

As FIG. 1 further illustrates, link partners 110 and 120 also include energy efficiency control policy entities 118 and 128, respectively, that implement features of the present invention. In general, energy efficiency control policy entities 118 and 128 can be designed to determine when to enter an energy saving state, what energy saving state (i.e., level of energy savings) to enter, how long to remain in that energy saving state, what energy saving state to transition to out of the previous energy saving state, etc.

In general, energy efficiency control policy entities 118 and 128 can comprise suitable logic, circuitry, and/or code that may be enabled to establish and/or implement an energy efficiency control policy for the network device. In various embodiments, energy efficiency control policy entities 118 and 128 can be a logical and/or functional block which may, for example, be implemented in one or more layers, including portions of the PHY or enhanced PHY, MAC, switch, controller, or other subsystems in the host, thereby enabling energy-efficiency control at one or more layers.

In one example, energy efficient Ethernet such as that defined by IEEE 802.3az can provide substantial energy savings through the use of a low power idle mode and/or subrating. In general, the low power idle mode can be entered when a transmitter enters a period of silence when there is no data to be sent. Power is thereby saved when the link is off. Refresh signals can be sent periodically to enable wake up from the sleep mode.

Subrating can be used to reduce the link rate to a sub-rate of the main rate, thereby enabling a reduction in power. In one example, this sub-rate can be a zero rate, which produces maximum power savings.

One example of subrating is through the use of a subset PHY technique. In this subset PHY technique, a low link utilization period can be accommodated by transitioning the PHY to a lower link rate that is enabled by a subset of the parent PHY. In one embodiment, the subset PHY technique is enabled by turning off portions of the parent PHY to enable operation at a lower or subset rate (e.g., turning off three of four channels). In another embodiment, the subset PHY technique can be enabled by slowing down the clock rate of a parent PHY. For example, a parent PHY having an enhanced core that can be slowed down and sped up by a frequency multiple can be slowed down by a factor of 10 during low link utilization, then sped up by a factor of 10 when a burst of data is received. In this example of a factor of 10, a 10G enhanced core can be transitioned down to a 1G link rate when idle, and sped back up to a 10G link rate when data is to be transmitted.

In general, both the subrating and low power idle techniques involve turning off or otherwise modifying portions of the PHY during a period of low link utilization. As in the PHY, power savings in the higher layers (e.g., MAC) can also be achieved by using various forms of subrating as well.

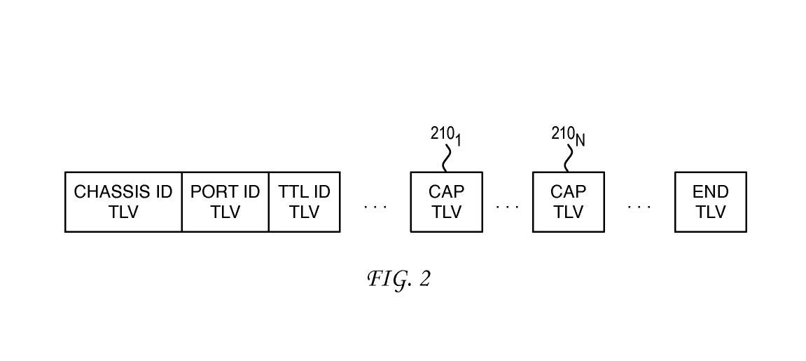

As noted, higher-layer protocol messaging (e.g., LLDP) can be used to enable energy efficient Ethernet network capability and feature exchange between link partners 110 and 120. In one embodiment, LLDP messaging according to the present invention can be based on formatted TLVs (type-length-value) that are defined for communication of energy efficiency control policy capabilities between link partners. The formatted TLVs can be carried within a LLDP frame that is based on an LLDP Data Unit (LLDPDU). As illustrated in FIG. 2, the LLDPDU used by the present invention can include a Chassis ID TLV, Port ID TLV, and Time To Live (TTL) TLVs. Additionally, the LLDPDU can also include a plurality of energy efficiency control policy capabilities (CAP) TLVs 210₁-210_{N}.

In general, CAP TLVs 210₁-210_{N} are configured to advertise energy efficiency control policy features/capabilities that are supported by a link partner. As would be appreciated, a particular link partner can include a PHY that supports a different iteration of an evolving set of energy efficiency control policy features/capabilities as compared to the PHY in its link partner. For example, one PHY may support one type of subrating (e.g., LPI mode) while another PHY may be configured to support a different type of subrating (e.g., subset PHY mode). Even within a given type of subrating, different PHYs can support different energy-saving capabilities, such as wake up times from a given energy efficiency operating mode.

As would be appreciated, numerous variations in energy efficiency control policy features/capabilities can be supported across various link partner devices. Here, what is significant is that the leveraging of any such energy efficiency control policy features/capabilities would be dependent on a mechanism to form an agreement between link partners on energy efficiency control policy features/capabilities that will be implemented in a given link.

Returning to the example Ethernet link of FIG. 1, it is noted that the Ethernet link can include OTN equipment 130, 140, which are configured to transport Ethernet over the optical link between OTN equipment 130, 140. As would be appreciated, OTN equipment 130, 140 can include a G.709 mapper along with PHY functionality. If link partners 110, 120 have exchanged LLDP messaging to configure energy efficiency control policy operation, then subsequent energy efficiency signaling between link partners 110, 120 can disrupt the operation of legacy PCS in OTN equipment 130, 140, thereby resulting in a disruption to the Ethernet link between link partners 110, 120.

It is therefore a feature of the present invention that a secondary startup condition beyond an energy efficiency feature exchange is provided to prevent Ethernet link disruption. In one embodiment, the link partners are designed to transmit an initiation signal to its link partner. In general, this initiation signal can be a signal that is at least semi-acceptable to the legacy device in the OTN equipment. Here the semi-acceptable nature of the initiation signal would cause either no action by the OTN equipment that receives the initiation signal or an inconsequential action (e.g., error report) that does not disrupt the operation of the Ethernet link. In one embodiment, the initiation signal can be a PCS code group that is either reserved or unused.

As part of the energy efficiency configuration process, the link partners are designed to identify receipt of the initiation signal and respond with defined energy efficiency signaling. The secondary startup condition is based on the receipt of the defined energy efficiency signaling on its receiver. As would be appreciated, the specific form of the defined energy efficiency signaling would be implementation dependent.

Where the link partners are directly connected together, then the secondary startup condition would complete and the configuration process would continue in association with an energy efficiency feature exchange. Where, on the other hand, the link partners are connected using OTN equipment, the legacy PCS within the OTN equipment would either do nothing with the initiation signal or generate a single error without disrupting the Ethernet link. Significantly, the legacy PCS would not forward the initiation signal on to the other link partner. As the other link partner would fail to receive the initiation signal, the defined energy efficiency signaling would not be returned to complete the secondary startup condition. In effect, the secondary startup condition is designed to identify the topology of the Ethernet link, which identification can be used to determine whether or not to configure the link with energy efficiency features.

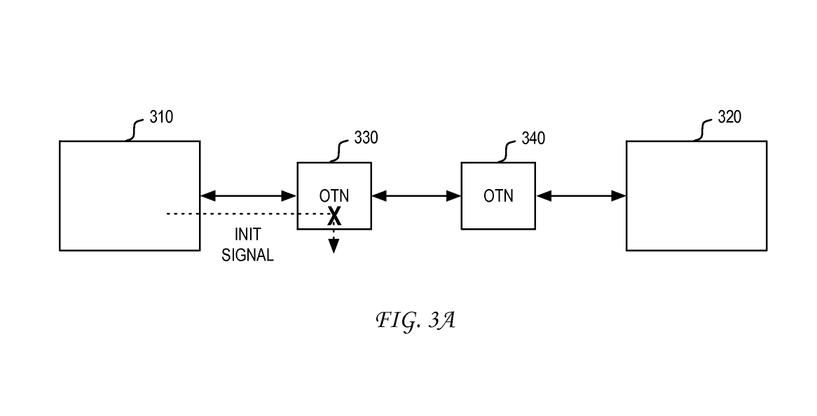

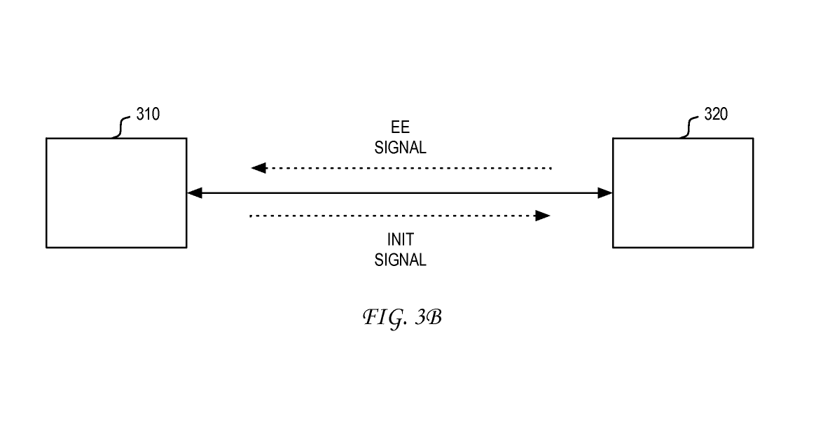

FIG. 3A further illustrates the secondary startup condition in an Ethernet link that includes OTN equipment. As illustrated, the Ethernet link supports communication between a first link partner 310 and a second link partner 320, which link partners can include those components described above with respect to FIG. 1. The Ethernet link further includes OTN equipment 330 and 340.

As illustrated, link partner 310 can be configured to implement the secondary startup condition by transmitting an initiation signal on the link. This initiation signal that is received by OTN equipment 330, is at least semi-acceptable to OTN equipment 330 in that the initiation signal would cause either no action by OTN equipment 330 or an inconsequential action by OTN equipment 330. The Ethernet link between link partner 310 and link partner 320 would not be disrupted. As illustrated in FIG. 3A, OTN equipment 330 would not forward the initiation signal onto OTN equipment 340. The failure to forward the initiation signal on to link partner 320 would therefore preclude its receipt by link partner 320.

FIG. 3B further illustrates the secondary startup condition in an Ethernet link that does not include OTN equipment. As illustrated, link partner 310 can be configured to implement the secondary startup condition by transmitting an initiation signal on the link. As link partner 310 is connected to link partner 320 without intervening legacy PCS equipment, the initiation signal is received by link partner 320. In response, link partner 320 would respond with defined energy efficiency signaling on the link, which defined energy efficiency signaling would be received by link partner 310. The secondary startup condition in the Ethernet link would therefore be satisfied.

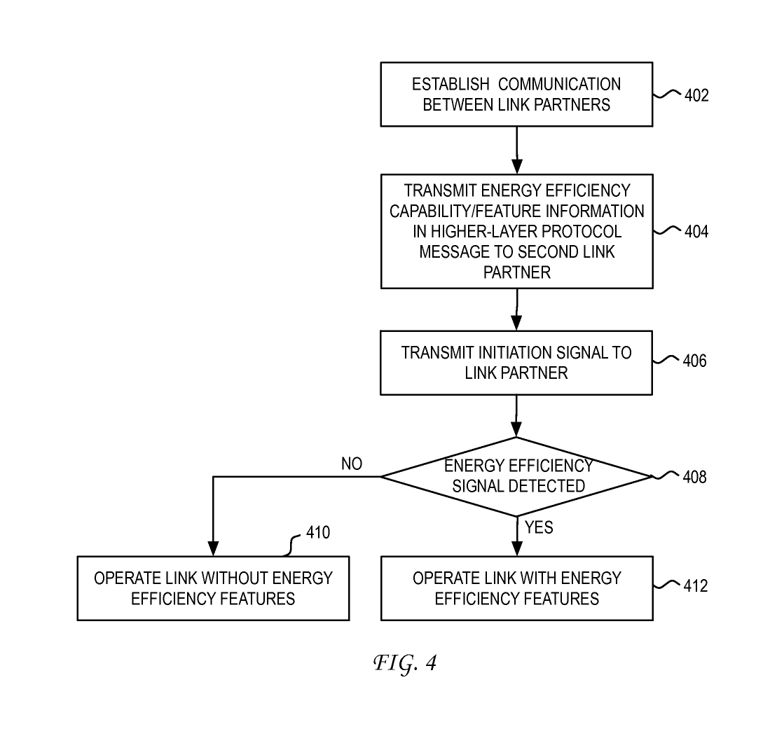

Having described a system framework of the present invention, reference is now made to FIG. 4, which illustrates a flowchart of an example process of the invention. As illustrated, the process begins at step 402 where communication is established between link partners. Here, it should be noted that the energy efficiency capabilities and feature exchange is deferred until startup conditions have been satisfied.

After communication is established on the Ethernet link, the process then proceeds to step 404 where energy efficiency capabilities and feature information is transmitted from a first link partner to a second link partner using a higher-layer protocol message. As noted above, an example of such a higher-layer protocol is LLDP.

Next, at step 406, an initiation signal is transmitted from the first link partner to the second link partner. At step 408, it is then determined whether a defined energy efficiency signal, that is transmitted in response to the receipt of the initiation signal by the second link partner, is detected at the receiver of the first link partner.

If it is determined at step 408 that the defined energy efficiency signal is detected at the receiver, then the state machine governing an energy efficiency control policy of the first link partner can be activated and the Ethernet link is operated, at step 412, with energy efficiency features as determined through the capability exchange. As noted, this can occur, for example, where the link partners are connected directly together.

If, on the other hand, it is determined at step 408 that the defined energy efficiency signal is not detected at the receiver, then the state machine in the first link partner that governs an energy efficiency control policy is not activated. As noted, this can occur, for example, where the link partners are connected via OTN equipment, wherein the OTN equipment having legacy PCS are not configured to forward the initiation signal. As a consequence of failing to receive the defined energy efficiency signal, the Ethernet link is not operated with energy efficiency features at step 410.

Here, it should be noted that the determination of whether or not a startup condition was successfully completed enables significant variation in the energy efficiency control policy startup process. In general, the existence of step 408 as a startup condition would allow for a variance in the order of steps 404 and 406. In other words, steps 404 and 406 need not be completed in the sequence as illustrated. In one embodiment, the energy efficiency capability exchange can occur after the determination of step 408. In another embodiment, the energy efficiency capability exchange occurs prior to the determination of step 408. In yet another embodiment, the energy efficiency capability exchange is contemporaneous with the determination of step 408.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A method, comprising:
after establishing communication by a first link partner with a second link partner, transmitting a first link layer protocol packet from said first link partner to said second link partner, said first link layer protocol packet advertising first energy efficiency control policy capabilities that are supported by said first link partner;
after establishing communication by said first link partner with said second link partner, transmitting a physical coding sublayer code group from said first link partner to said second link partner;
activating a state machine that governs an energy efficiency control policy in said first link partner upon receipt of energy efficiency signaling by said first link partner that is transmitted from said second link partner, wherein said transmission of said energy efficiency signaling by said second link partner is conditioned on receipt by said second link partner of said physical coding sublayer code group.

2. The method of claim 1, wherein said first link layer protocol packet is a Link Layer Discovery Protocol (LLDP) packet.

3. The method of claim 1, further comprising receiving a second link layer protocol packet by said first link partner from said second link partner, said second link layer protocol packet advertising second energy efficiency control policy capabilities that are supported by said second link partner.

4. The method of claim 3, wherein capabilities of said energy efficiency control policy is based on a comparison of said first energy efficiency control policy capabilities that are supported by said first link partner and said second energy efficiency control policy capabilities that are supported by said second link partner.

5. The method of claim 4, wherein said energy efficiency control policy supports a low power idle mode.

6. The method of claim 4, wherein said energy efficiency control policy supports a subset physical layer device mode.

7. The method of claim 1, wherein said transmission of said first link layer protocol packet occurs after said transmission of said physical coding sublayer code group.

8. The method of claim 1, wherein said transmission of said first link layer protocol packet occurs before said transmission of said physical coding sublayer code group.

9. A method, comprising:
prior to activation of a controller that governs an energy efficiency control policy in said first link partner, transmitting a first link layer protocol packet from said first link partner to said second link partner via said fiber optic network cable, said first link layer protocol packet advertising first energy efficiency control policy capabilities that are supported by said first link partner;
prior to activation of a controller that governs an energy efficiency control policy in said first link partner, transmitting a physical coding sublayer code group from said first link partner to said second link partner; and
conditioning an activation of said controller based on a receipt of energy efficiency signaling by said first link partner that is transmitted from said second link partner, wherein said transmission of said energy efficiency signaling by said second link partner is conditioned on receipt by said second link partner of said physical coding sublayer code group.

10. The method of claim 9, wherein said link layer protocol packet is a Link Layer Discovery Protocol (LLDP) packet.

11. The method of claim 9, further comprising receiving a second link layer protocol packet by said first link partner from said second link partner, said second link layer protocol packet advertising second energy efficiency control policy capabilities that are supported by said second link partner.

12. The method of claim 11, wherein capabilities of said energy efficiency control policy is based on a comparison of said first energy efficiency control policy capabilities that are supported by said first link partner and said second energy efficiency control policy capabilities that are supported by said second link partner.

13. The method of claim 12, wherein said energy efficiency control policy supports a low power idle mode.

14. The method of claim 12, wherein said energy efficiency control policy supports a subset physical layer device mode.

15. The method of claim 9, wherein said transmission of said first link layer protocol packet occurs after said transmission of said physical coding sublayer code group.

16. The method of claim 9, wherein said transmission of said first link layer protocol packet occurs before said transmission of said physical coding sublayer code group.

17. A method, comprising:
prior to activation of a controller that governs an energy efficiency control policy in said first link partner, transmitting a physical coding sublayer code group from said first link partner to said second link partner; and
conditioning an activation of said controller based on a receipt of energy efficiency signaling by said first link partner that is transmitted from said second link partner, wherein said transmission of said energy efficiency signaling by said second link partner is conditioned on receipt by said second link partner of said physical coding sublayer code group.
